(19) United States
(12) Patent Application Publication
(10) Pub. No.: US 2014/0115868 A1
(43) Pub. Date: May 1, 2014

(54) Coupling System to Reduce Vibration

(71) Applicant: Gregory Ruhlander, Frisco, TX (US)

(72) Inventor: Gregory Ruhlander, Frisco, TX (US)

(21) Appl. No.: 13/662,700

(22) Filed: Oct. 29, 2012

(51) Int. Cl. F16B 33/00; B23P 11/00; F16B 37/00

(52) U.S. Cl. 29/525.02; 411/368; 411/427

(57) ABSTRACT

In various implementations, a coupling system may be utilized to couple part(s) and/or reduce the transfer of vibration between coupled parts. The coupling system may include a nut with an annular recess, a damper, and/or a fastener.

### TECHNICAL FIELD

The present disclosure relates to couplings, and more particularly to couplings that dampen vibration.

### BACKGROUND

Parts that exert vibrational forces, such as heat exchanger coils in heat pumps, air conditioners, and/or refrigerators, are often coupled to other parts, such as housings. The transfer of the vibrational force from one part to another may cause noise, wear on components and/or damage to parts.

### SUMMARY

In various implementations, a coupling system to inhibit transfer of vibrational forces between parts coupled by the coupling system may include a threaded fastener, a damper, and a nut. The damper may deform and inhibit transfer of vibrational forces. The damper may include an opening to receive the fastener. The nut may include a threaded recess to couple with the threaded fastener and an annular recess disposed about the threaded recess. The annular recess may receive at least a portion of the damper.

Implementations may include one or more of the following features. The damper may at least partially deform as the fastener engages with the nut. The annular recess may receive at least part of the deformed portion of the damper and/or contain the deformed portion of the damper. The damper may at least partially include an elastically deformable material. The threaded fastener may include an elongated member with an outer surface. The outer surface may include a threaded portion. The damper may be coupled to the nut. The damper may include an elongated member and the opening that receives the fastener may be disposed in the elongated member. The opening of the damper may include a first recess to receive a protrusion of the nut. The annular recess of the nut may be a predetermined size that applies a predetermined force on a part when the damper is deformed. At least part of the deformed portion of the damper may be disposed in the annular recess. The coupling system may include a first part that includes a housing and a second part that includes a heat exchanger that may be at least partially disposed in the housing. The heat exchanger may exert a vibrational force during use. The coupling system may couple the first part and the second part and may at least partially inhibit transfer of the vibrational force from the second part to the first part.

In various implementations, a coupling system may include a nut. The nut may include a threaded recess to couple with a threaded fastener and an annular recess disposed about the threaded recess. The annular recess may receive at least a portion of a damper. The coupling system may inhibit transfer of vibrational forces between parts coupled by the coupling system.

Implementations may include one or more of the following features. The annular recess may include a ring shaped recess. The nut may include a protrusion disposed between the annular recess and the threaded recess. The protrusion may incude an annular protrusion. The coupling system may include a damper coupled to the nut. The threaded recess may include an opening disposed in the nut. The annular recess may include a predetermined volume. As the fastener engages the nut, the damper may be deformed and the coupling system may maintain a predetermined force when at least part of a deformed portion of the damper is disposed in the annular recess.

In various implementations, a torque may be applied to a threaded fastener disposed at least partially in a damper and a nut and at least a portion of the damper may be allowed to deform into an annular recess of the nut by the application of the torque. Transfer of vibrational forces is at least partially inhibited by at least a portion of the damper in the annular recess.

Implementations may include one or more of the following features. At least a first part and a second part may be coupled using the threaded fastener and the nut, and transfer of at least a portion of the vibrational force from the first part to the second part may be inhibited using at least a portion of the damper in the annular recess of the nut. A damper may be coupled to the nut.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIGS. 1A and 1B illustrate implementations of bottom and top perspective views of an example nut.

FIG. 2A illustrates an implementation of a perspective view of an example damper.

FIG. 2B illustrates an implementation of a perspective view of an example damper.

FIG. 3A illustrates an implementation of an example coupling between two parts.

FIG. 3B illustrates an implementation of an example coupling between two parts.

FIG. 4A illustrates an implementation of a cross-sectional view of an example coupling between two parts.

FIG. 4B illustrates an implementation of a cross-sectional view of an example coupling between two parts.

FIG. 5 illustrates an implementation of an example process for coupling parts.

Like reference symbols in the various drawings indicate like elements.

### DETAILED DESCRIPTION

In various implementations, a coupling system may be utilized to couple two or more parts together. In some implementations, at least one of the parts may exert a vibrational force (e.g., on at least one other part and/or on the coupling system). For example, a heat pump and/or air conditioner may include a part, such as a heat exchanger that generates and/or exerts a vibrational force during use. The heat exchanger may be mounted or otherwise coupled to a housing (e.g., directly or indirectly by using a mounting such as a bracket). To inhibit and/or eliminate the transfer of the vibrational forces from the heat exchanger to the housing, the coupling system may be utilized to couple the heat exchanger to the housing. For example, at least one of the parts may include a metal, and the coupling system may inhibit direct contact between the parts such that corrosion is inhibited due to exposure to hot and/or cold temperatures, dirt, rain, and/or wear due to contact between the two parts.

The coupling system may include a nut, a damper, and a fastener. During use the fastener may be disposed at least partially in the damper. The fastener may engage at least a portion of the nut, such as with one or more of the threads in a threaded recess of a nut. As a torque is applied to the fastener and/or to the nut to further couple the fastener and the nut (e.g., such that the fastener and the nut are further engaged and drawn closer to each other), the damper may deform. An annular recess in the nut may receive at least a portion of the damper (e.g., at least a portion of the deformed section of the damper).

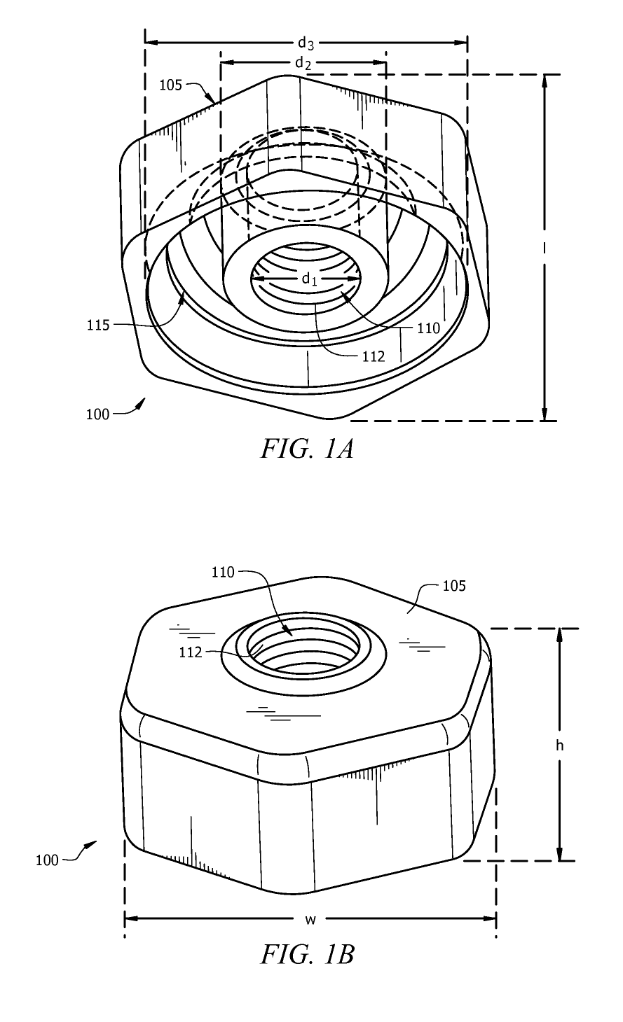

FIGS. 1A and 1B illustrate an implementation of bottom and top perspective views, respectively, of an example nut 100. The nut 100 may include a nut head 105. The nut head 105 may be configured to engage a tool, such as a wrench, a crescent wrench, and/or a socket wrench.

The nut 100 may include a threaded recess 110. The threaded recess 110 may be an opening disposed through the nut 100 (e.g., through the nut head 105). In some implementations, the threaded recess 110 may be disposed about an axis normal to the nut head 105. The threaded recess 110 may be disposed proximate a center of a cross-section of the nut 100. The threaded recess 110 may include a portion with threads 112. The threaded portion 112 may couple with a fastener received within the threaded recess 110. For example, the threads on a fastener may engage with the threaded portion 112 of the threaded recess 110.

The nut 100 may include an annular recess 115. The annular recess 115 may be disposed about the same axis as the threaded recess 110, in some implementations. For example, the threaded recess 110 may be a recess disposed proximate a center of the annular recess 115.

The annular recess 115 may have a predetermined size and/or cross-sectional shape. For example, the annular recess 115 may be an annular ring-shaped recess and/or include a predetermined volume. The predetermined volume of the annular recess 115 may be selected, for example, based on properties of the damper (e.g., deformation properties, material, size, and/or shape), an amount of force to be applied, and/or an amount of vibrational force transfer to be inhibited.

The nut 100 may have a length, l, width, w, and height, h. For example, the nut 100 may have a length of approximately 1 inch to approximately 0.75 inches. The threaded recess 110 may have a diameter, d1. The diameter d1 of the threaded recess 110 may be approximately 0.2 inches to approximately 0.3 inches. The annular recess 115 may have a predetermined length and/or predetermined volume. The annular recess 115 may have an inner diameter, d2, and an outer diameter, d3. The inner diameter d2 of the annular recess 115 may be approximately 0.2 inches to approximately 0.3 inches. The outer diameter d3 of the annular recess 115 may be approximately 0.5 inches to approximately 0.7 inches. The height, h, may be selected such that a specified volume of damper may be deformed in the annular recess 115. A wall of the annular recess 115 and/or an inner wall of the nut 100 may retain at least a portion of the damper in the annular recess 115.

Although FIGS. 1A and 1B illustrates a nut head 105, a threaded recess 110, and an annular recess 115 with particular cross-sectional shapes, any appropriate cross-sectional shapes may be utilized. For example, the nut head 105 may have a round, square, hexagonal, octagonal, and/or other regular or irregular shaped cross-section. The annular recess 115 may have an oval, a square, and/or any other regular or irregular shaped cross-section. Although dimensions are described as diameters, cross-sectional shapes other than circles may also have similar dimensions, in some implementations.

The coupling system may include a damper. The damper may include a material capable of absorbing forces and/or inhibiting force transfer (e.g., by reducing, deadening, and/or damping forces exerted on the damper). For example, the damper may include a material that reduces noise or energy transfer and/or reduces damage due to forces received. The damper may include rubber (e.g., natural and/or synthetic rubber, such as ethylene propylene diene momomer rubber) and/or an elastomer. The damper may include a corrosion-resistant material. The damper may include at least a portion that is deformable (e.g., elastic and/or inelastic deformation).

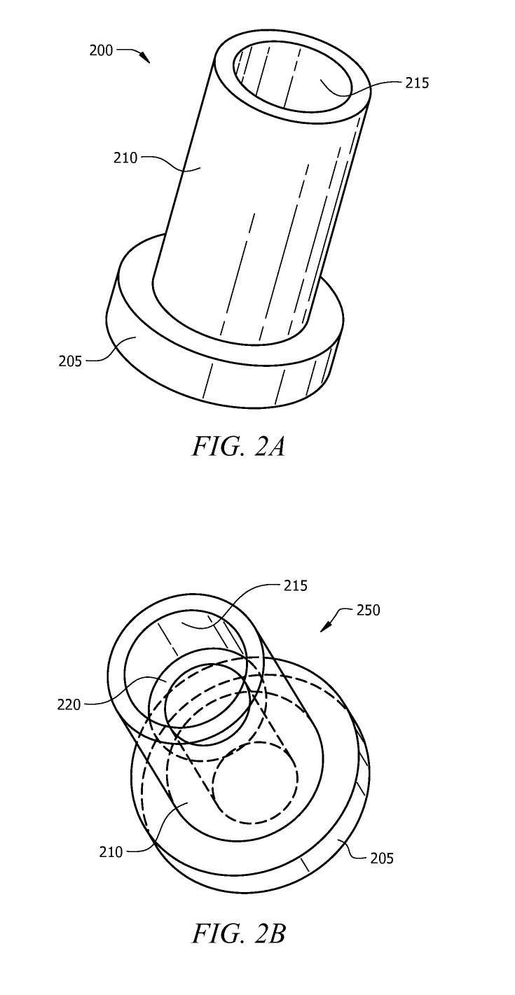

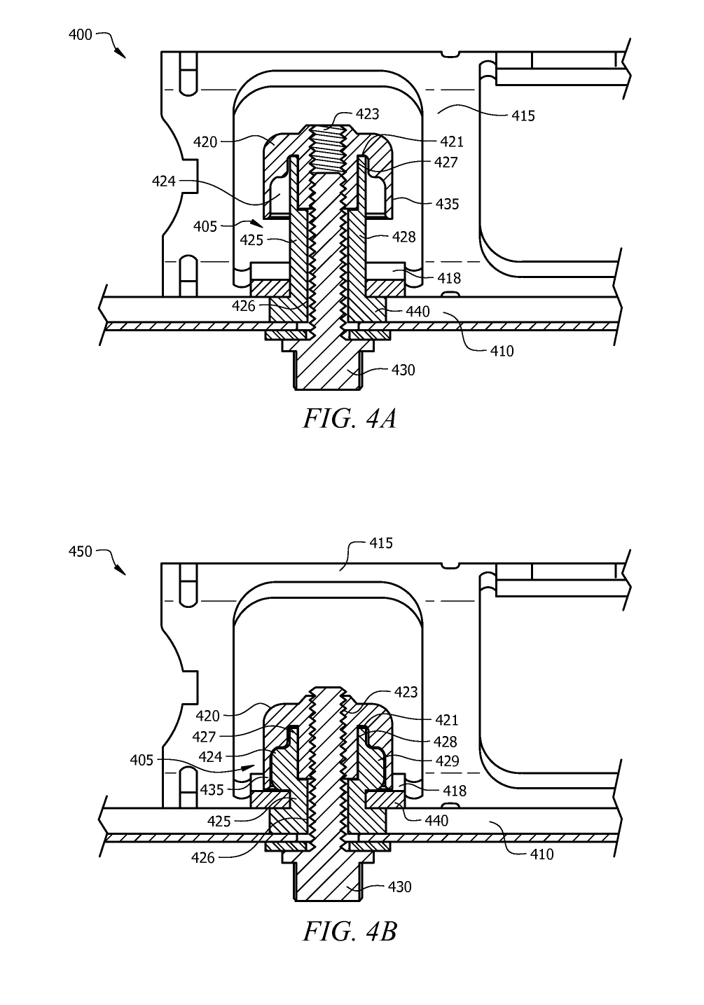

FIGS. 2A and 2B illustrate implementation of example damper 200, 250. The damper 200, 250 may include a flange 205 and an elongated member 210. The flange 205 may be disposed proximate an end of the damper 200, 250. The flange 205 may have a shape to facilitate positioning the coupling system and/or inhibit the transfer of vibration forces between coupled parts. In some implementations, the flange 205 may have a similar cross-sectional length (e.g., diameter) to the cross-sectional length (e.g., diameter) of the elongated member 210 of the damper 200, 250 when deformed, for example, as illustrated in FIG. 4B.

The elongated member 210 may have a cross-sectional shape and/or length to facilitate coupling with the nut 100 and/or a fastener. The elongated member 210 may have a volume such that, when used in the coupling member, the damper 200, 250 applies a predetermined compression and/or the damper 200, 250 provides a predetermined amount of damping.

The elongated member 210 may include an opening 215 extending therethrough. The opening 215 may extend through the flange 205. The opening 215 may be shaped and/or sized to receive a threaded fastener. For example, the opening 215 may have a larger diameter than a diameter of a threaded fastener. The opening 215 may include a recess 220, as illustrated in FIG. 2B, such that a portion of a nut (e.g. a wall of the threaded recess 110 of a nut 100) may be disposed in the recess 220. For example, a wall of a recess 220 may couple (e.g., contact) with a wall of a nut 100, such as an outer wall of a threaded recess 110 and/or an inner wall of an annular recess 115.

In some implementations, the nut and the damper may be a single unit. For example, the damper may be over molded on the nut such that the nut and the damper are a single unit. The damper may be coupled (e.g., affixed and/or adhered) to the nut, in some implementations.

The fastener may include a portion configured to couple to a nut, such as a threaded portion. The fastener may include a head and the fastener head may include a portion to engage a tool, such as a screwdriver, wrench, crescent wrench, socket wrench, etc. For example, the fastener may be a screw and may be coupled to the nut with a screwdriver. Any appropriate fastener may be utilized.

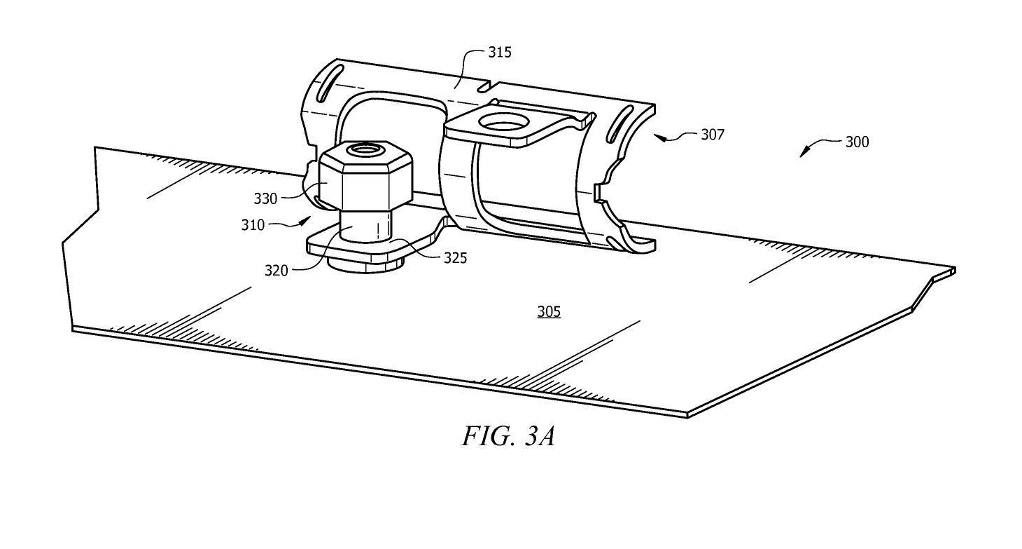

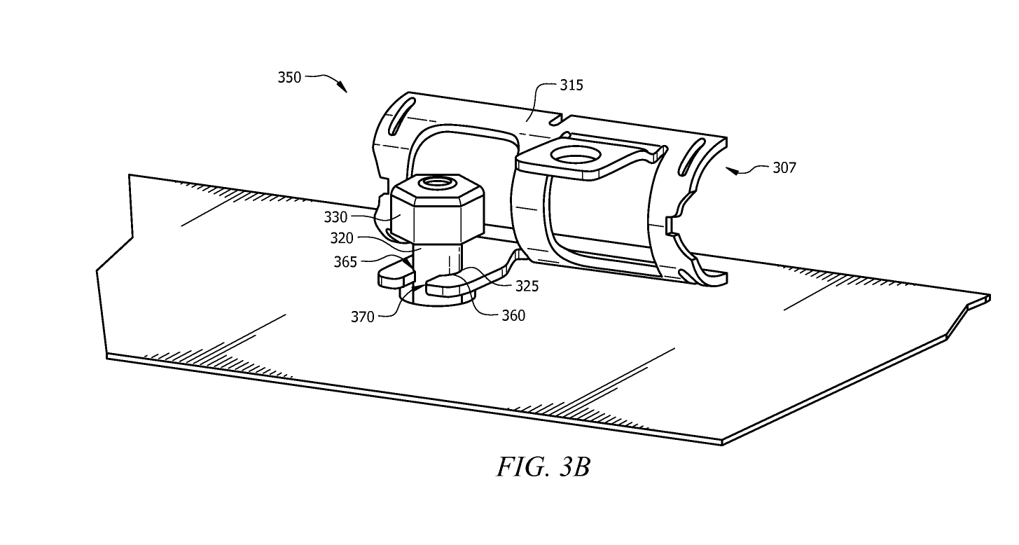

FIG. 3A illustrates an implementation of a portion of an example coupling 300 of parts via a coupling system 310. FIG. 3B illustrates an implementation of a portion of an example coupling 350 of parts via a coupling system 310. For example, a first part 305 and at least a portion of a second part 307 of an air conditioner may be coupled using the coupling system 310. The first part 305 of the air conditioner may include a housing and the second part 307 may include a heat exchanger or portions thereof (e.g., heat exchanger coil and/or mounting, such as a bracket 315). At least a portion of the second part 307 may generate vibrational forces during use. For example, during use, a heat exchanger may vibrate and/or cause vibration of the mounting. To inhibit transfer of the vibrational forces from the second part 307 to the first part 305, the coupling system may be utilized.

A first part 305 and a bracket 315 of the second part 307 may be coupled using the coupling system 310. The coupling system 310 may include a nut 330 and a damper 320. The damper 320 may be at least partially disposed in a portion of the second part 307. The damper 320 may be disposed at least partially in an opening 325 of the bracket 315. The nut 330 may be coupled to the damper 320 and/or the fastener (not shown) and retain the damper 320 at least partially in the opening 325.

As illustrated in FIG. 3A, the opening 325 in the bracket 315 may be a hole in a portion of the bracket. The opening 325 may have a shape and/or size to retain the coupling system 310 in the opening. For example, the nut 330 may have a width that is greater than a width (e.g., diameter) of the opening 325 of the bracket 315. The damper 320 may be inserted through the opening 325 of the bracket 315, during use. The opening 325 may have a size such that at least a portion of the damper 320 may be deformed to allow the damper to pass at least partially through the opening. In some implementations, the opening 325 may have a size and/or a shape that allows the damper 320 to at least partially pass through the opening without substantially deforming the damper 320. A flange 322 of the damper 320 may have a width greater than the opening 325 of the bracket 315. The flange 322 may at least partially retain the damper in the opening 325 of the bracket 315.

The opening 325 of the bracket 315 may have various sizes and/or shapes, as appropriate. As illustrated in FIG. 3B, the opening 325 may be a C-shaped opening.

The bracket 315 may include a notch 370. The notch 370 may be coupled 365 to the opening 325. The notch 370 may have a width that is less than a width of the opening 325. Thus, a portion of the coupling system 310 disposed at least partially in opening 325 may be retained in the opening and/or restricted from passing through notch 370 (e.g., the notch may have a width that is less than a width of the damper). As illustrated in FIG. 3B, the notch 370 and the opening 325 may be disposed in the bracket 315 such that at least a portion of the coupling system 310 may pass at least partially through the notch to be disposed in the opening in the bracket. For example, the damper 320 of the coupling system 310 may be overmolded to nut 330. The opening 325 of the bracket may have a size and/or a shape such that the nut 330 and a flange may be restricted from being inserted through the opening 325. Thus, the damper 320 may be at least partially deformed to pass at least partially through the notch 370 and at least partially into the opening 325.

In some implementations, the first part 305 may include an opening configured to receive a fastener to couple the second part 307 to the first part 305 through the bracket 315. In some implementations, the bracket 315 may be a part of and/or coupled to the second part 307.

FIGS. 4A and 4B illustrate cross-sectional views of an implementation of an example coupling system 405 at a first position 400 and at a second position 450, respectively. The example coupling system 405 may be utilized to couple a first part 402 to a bracket 410 of a second part 415. The example coupling system 405 comprises a nut 420, a damper 425, and a fastener 430.

As illustrated in FIG. 4A, the nut 420 may be coupled to the damper 425. For example, the nut 420 may include an annular recess 424 and an upper recess 421 to receive at least a portion of the damper 425, such as an end 427 of the elongated portion 428 of the damper 425. A fastener 430 may be disposed at least partially within an opening 426 of the damper 425 and/or at least partially within the threaded recess 423 of the nut 420. A torque may be applied to the nut 420 and/or the fastener 430 to couple the nut 420, the damper 425 and the fastener 430 together. For example, a tool, such as a screwdriver may be utilized to apply a torque to the fastener 430 and/or a wrench may be applied to the nut 420 to inhibit movement of the nut 420 relative to the fastener 430. The threads 422 of the fastener 430 may engage the threaded recess 423 of the nut 420, and the nut 420 and fastener 430 may move towards each other to the second position 450 illustrated in FIG. 4B.

As the nut 420 and the fastener 430 move towards each other (e.g., from the first position 400 of FIG. 4A to the second position 450 of FIG. 4B), the damper 425 may deform. For example, the elongated portion 428 of the damper 425 may deform radially (e.g., deformed portion 429). The deformation may be at least partially contained and/or retained by the upper recess 421 and annular recess 424 of the nut 420. In some implementations, a wall 435 of the nut 420 may contact at least a portion 418 of a bracket 415, flange 440 of a damper 425, fastener 430, a washer, and/or portion of the first part 410. The flange 440 of the damper 425 may be disposed in a recess in the first part 410.

In some implementations, a cross-sectional width of the deformed elongated portion 429 of the damper 425 may have a similar width to a width of the flange 440 of the damper 425, as illustrated in FIG. 4B. The nut wall 435 may at least partially contain and/or retain the deformed portion 429 of the damper 425. In some implementations, at least part of the deformed portion 429 may be disposed outside the annular recess 424 of the nut 420. In some implementations, the deformed portion 429 of the damper 425 may be contained by the annular recess 424 of the nut 420.

The second position 450 may maintain a predetermined force (e.g., compression force) on at least one of the coupled parts. The second position 450 may allow transfer of vibrational forces to be inhibited by the damper 425 by maintaining deformed portion 429 of damper 425 in a predetermined configuration and/or amount of damper 425 about the fastener 430. In some implementations, the damper 425 may deform in an approximately uniform manner about the fastener 430 and the nut 420.

During use, the vibrational forces of the second part and/or corrosive factors (e.g., heat, cold, moisture) to which the coupling system is subjected may cause the damper to wear. For example, the damper may reduce in size, leech in one direction, and/or wear unevenly. Since the nut maintains at least a portion of the deformed damper in the annular recess of the nut, a predetermined amount of vibration reduction (e.g., due to inhibition by the damper) may be achieved. In addition, the annular recess may at least partially protect the damper from wear. For example, a wall of the annular recess may inhibit leeching. In some implementations, the wall of the annular recess may reduce the exposure of the deformed damper to wearing conditions (e.g., excessive temperatures and/or moisture).

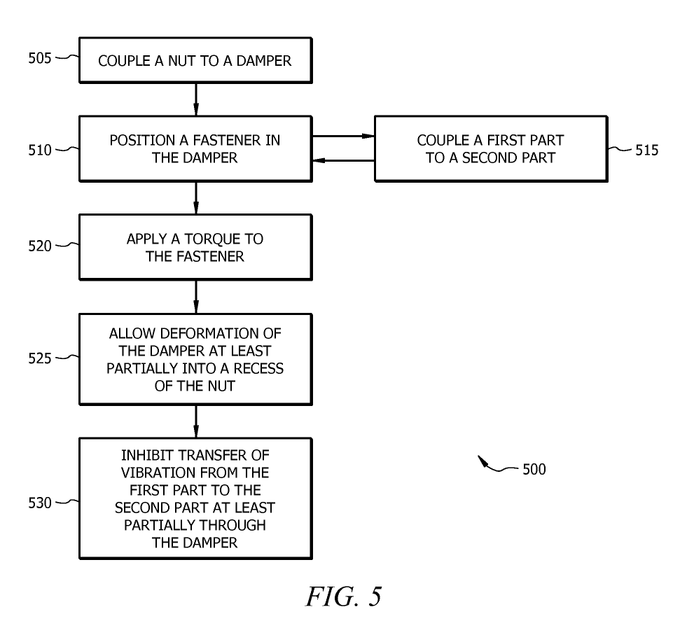

FIG. 5 illustrates an implementation of an example process 500 for coupling part(s). A nut may be coupled to a damper (operation 505). For example, a wall of the threaded recess of the nut may be disposed in a recess (e.g., a countersink) of an opening of the damper. In some implementations, the damper may be overmolded to the nut. For example, an end of the elongated member of the damper may be coupled to the nut and another end of the elongated member may be proximate the flange.

A fastener may be positioned in the damper (operation 510). The fastener may be disposed at least partially in an opening of the damper. At least a portion of the fastener may pass through the opening of the damper to couple with at least a portion of the threads of the threaded recess of the nut.

A first part may be at least partially coupled to a second part (operation 515). For example, the first part and/or the second part may include coupling portions (e.g., openings in a portion of the part) configured to receive the coupling system. The coupling system may couple the first part and the second part at least partially using coupling portions.

A torque may be applied to the fastener (operation 520). The torque may be applied with a tool (e.g., screwdriver and/or by hand) and/or the fastener may be otherwise actuated. For example, a fastener may be turned such that at least a portion of the threads of the fastener engage with at least a portion of the threads of a threaded recess of the nut.

Deformation of the damper at least partially into an annular recess of the nut may be allowed (operation 525). As the torque is applied to the fastener, the elongated portion of the damper may be subject to the torque and deform. The deformation of the damper to an area proximate the annular recess of the nut may facilitate the reduction of vibrational force transfer. Properties of the annular recess (e.g., cross-sectional shape, width, volume, inner diameter and/or outer diameter) may be selected to maintain a property of the damper (e.g., maintain a force and/or maintain an ability to inhibit transfer of vibrational forces). For example, over time a damper may lose approximately twenty percent of its total volume (e.g., due to age, vibration, and/or exposure). By allowing the annular recess to contain at least twenty percent more damper (e.g., volume in annular recess) than an amount that will satisfy the selection application requirements, the use of the damper and/or coupling system may be extended (e.g., the coupling system may meet selected application requirements for a greater period than when using a nut without an annular recess).

Transfer of vibration from a first part to a second part may be inhibited at least partially through the damper (operation 530). A second part may transfer vibrational forces due to generation of vibrational forces and/or due to being subjected to vibrational forces from other parts to which that the second part is coupled. The coupling system may at least partially inhibit the transfer of the vibrational forces from the second part to the first part. In some implementations, the coupling system may at least partially inhibit transfer of vibrational forces from the first part to the second part.

Process 500 may be implemented by various systems, such as systems 100, 150, 200, 250, 300, 400, and/or 450. In addition, various operations may be added, deleted, and/or modified. For example, a torque may be applied to the fastener and/or the nut. In some implementations, one component of the coupling system (e.g., a fastener and/or nut) may be restricted from movement (e.g., using a wrench) while torque is applied to another component to couple two or more parts. In some implementations, the transfer of vibration between at least two parts may be at least partially inhibited.

In some implementations, a coupling system may be selected from a kit. The kit may include a plurality of nuts (e.g., different sizes, different nut heads, different sizes and/or shapes of annular recesses), dampers (e.g., different sizes and/or shapes and/or including different materials), and/or fasteners (e.g., different sizes and/or types). When a coupling system is needed for a particular application, a nut, a damper(s), and/or a fastener may be selected based at least partially on properties of the application (e.g., amount of force to be maintained by the coupling system such as to maintain deformation of the damper, amount of inhibition of vibrational forces to be allowed, environmental conditions, such as exposure to heat and/or acidic environmental conditions). The selected components (e.g., nut, damper(s), and/or fastener) of the coupling system may then be actuated such that at least two parts are coupled together.

Although a bracket has been described in various implementations as indirectly coupling a first part and a second part, the first part and the second part may be coupled directly and/or indirectly. In some implementations, the bracket may be a portion of the first part and/or the second part. In some implementations, the first part and/or the second part may include a portion configured to receive at least a portion of the coupling system (e.g., recess, openings, and/or protrusions). Although a coupling system has been described as including a nut, a damper, and a fastener, the coupling system may include other components such as washers and/or o-rings.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a part” includes a combination of two or more parts and reference to “a damper” includes different types and/or combinations of dampers. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A coupling system comprising:
a threaded fastener;
a damper adapted to deform and inhibit transfer of vibrational forces, wherein the damper comprises an opening adapted to receive the fastener; and
a nut comprising:
a threaded recess adapted to couple with the threaded fastener;
an annular recess disposed about the threaded recess and adapted to receive at least a portion of the damper;
wherein the coupling system is adapted to inhibit transfer of vibrational forces between parts coupled by the coupling system.

2. The coupling system of claim 1 wherein the coupling system at least partially deforms the damper as the fastener engages with the nut, wherein the annular recess is adapted to receive at least part of the deformed portion of the damper.

3. The coupling system of claim 1 wherein the coupling system at least partially deforms the damper as the fastener engages the nut, and wherein the annular recess contains the deformed portion of the damper.

4. The coupling system of claim 1 wherein the damper at least partially comprises an elastically deformable material.

5. The coupling system of claim 1 wherein the threaded fastener comprises an elongated member with an outer surface, and wherein the outer surface comprises a threaded portion.

6. The coupling system of claim 1 wherein the damper is coupled to the nut.

7. The coupling system of claim 1 wherein the damper comprises an elongated member, and wherein the opening adapted to receive the fastener is disposed in the elongated member.

8. The coupling system of claim 1 wherein the opening of the damper comprises a first recess adapted to receive a protrusion of the nut.

9. The coupling system of claim 1 wherein the annular recess of the nut is a predetermined size that applies a predetermined force on a part when the damper is deformed, and at least part of the deformed portion of the damper is disposed in the annular recess.

10. The coupling system of claim 1 further comprising:
a first part comprising a housing; and
a second part comprising a heat exchanger, wherein the heat exchanger exerts a vibrational force during use, and wherein the heat exchanger is at least partially disposed in the housing;
wherein the coupling system couples the first part and the second part, and wherein the coupling system at least partially inhibits transfer of the vibrational force from the second part to the first part.

11. A coupling system comprising:
a nut comprising:
a threaded recess adapted to couple with a threaded fastener; and
an annular recess disposed about the threaded recess and adapted to receive at least a portion of a damper;
wherein the coupling system is adapted to inhibit transfer of vibrational forces between parts coupled by the coupling system.

12. The coupling system of claim 11 wherein the annular recess comprises a ring shaped recess.

13. The coupling system of claim 11 wherein the nut further comprises a protrusion disposed between the annular recess and the threaded recess.

14. The coupling system of claim 13 wherein the protrusion comprises an annular protrusion.

15. The coupling system of claim 11 further comprising a damper coupled to the nut.

16. The coupling system of claim 11 wherein the threaded recess comprises an opening disposed in the nut.

17. The coupling system of claim 11 wherein the annular recess comprises a predetermined volume, and wherein the damper is deformed as the fastener engages the nut, and wherein the coupling system is adapted to maintain a predetermined force when at least part of a deformed portion of the damper is disposed in the annular recess.

18. A method comprising:
applying a torque to a threaded fastener disposed at least partially in a damper and a nut; and
allowing deformation of at least a portion of the damper into an annular recess of the nut by the application of the torque;
wherein at least a portion of the damper in the annular recess inhibits transfer of vibrational forces.

19. The method of claim 18 further comprising:
coupling at least a first part and a second part using the threaded fastener and the nut; and
inhibiting transfer of at least a portion of the vibrational force from the first part to the second part using at least a portion of the damper in the annular recess of the nut.

20. The method of claim 18 further comprising coupling a damper to a nut.
